(19) United States
(12) Patent Application Publication
(10) Pub. No.: US 2015/0033732 A1
(43) Pub. Date: Feb. 5, 2015

(54) AIR COMPRESSING DEVICE OF BIFUEL ENGINE

(71) Applicant: Hiroyuki HASEGAWA, Shizuoka (JP)

(72) Inventor: Hiroyuki HASEGAWA, Shizuoka (JP)

(21) Appl. No.: 13/957,302

(22) Filed: Aug. 1, 2013

(51) Int. Cl. F02M 21/02

(52) U.S. Cl. CPC F02M 21/0245; F02M 21/0287
USPC 60/602; 123/525; 60/299; 123/304; 60/611

(57) ABSTRACT

A supercharging device of a bifuel engine using a gas fuel and a liquid fuel as fuels, and having a supercharger supercharging or turbocharger turbocharging a large amount of intake air into a combustion chamber of the engine by driving a compressor arranged in an intake passage of the engine by an output shaft of the engine or an electric motor, performs the compressing by the compressor of the supercharger or turbocharger when the gas fuel is used, and does not perform the supercharging or turbocharging by the compressor of the supercharger or turbocharger when the liquid fuel is used.

### BACKGROUND OF THE INVENTION

1. Field of the Invention

The present invention relates to a supercharging or turbocharging device of a bifuel engine.

2. Description of the Related Art

Conventionally, a bifuel engine using a gas fuel such as CNG (Compressed Natural Gas) and a liquid fuel such as gasoline has been available.

A vehicle having a bifuel engine is provided with equipment such as a fuel tank, a fuel line, an injector and the like dedicated to the CNG in addition to equipment employed for the case of mounting an ordinary gasoline and a diesel engine. Consequently, weight of the vehicle having the bifuel engine significantly increases, and drive performance (power performance) of the vehicle lowers.

Accordingly, there has been a conventional bifuel engine having a turbocharger in which a turbine arranged in an exhaust passage of the engine drives a compressor arranged in an intake passage of the engine to compress a large amount of intake air into a combustion chamber of the engine, as shown in JP 63-22342 Y (Patent Document 1). The compression by the compressor of the turbocharger increases the output of the engine to compensate for the lowering of drive performance due to increase in vehicle weight.

However, the bifuel engine using the conventional turbocharger has the following problems.

(1) The compressing by the compressor of the turbocharger is performed on both the gas fuel of a high octane number (e.g., the CNG has the octane number of 120) and the liquid fuel of a low octane number (e.g., the gasoline has the octane number of 90-100). Thus, not only when the gas fuel is used but also when the liquid fuel is used, the control of the compressing pressure must be performed on the turbocharger so that the compressing pressure produced by the compressor of the turbocharger may be lower the lower limit value of the compressing pressure corresponding to the used fuel, for avoiding disadvantages such as damages to engine parts and output lowering due to occurrence of knocking.

(2) At the time of cold start of the engine, the temperature of the exhaust gas rotating the turbine of the turbocharger lowers due to contact with the turbine, and this delays temperature rising of an exhaust gas cleaning catalyst arranged downstream from the turbine. The delay of the temperature rising of the exhaust gas cleaning catalyst causes slowdown of its reducing performance, resulting in deterioration of the exhaust gas cleaning performance.

### SUMMARY OF THE INVENTION

An object of the invention is to increase easily an output of a bifuel engine.

Another object of the invention is to improve an exhaust gas cleaning performance by avoiding delay in temperature rising of an exhaust gas cleaning catalyst.

In accordance with the present invention, there is provided a supercharging device of a bifuel engine using a gas fuel and a liquid fuel as fuels, and having a supercharger supercharging a large amount of intake air into a combustion chamber of the engine by driving a compressor arranged in an intake passage of the engine by an output shaft of the engine or an electric motor. The supercharging by the compressor of the supercharger is performed when the gas fuel is used, and the supercharging by the compressor of the supercharger is not performed when the liquid fuel is used.

Furthermore, in accordance with the present invention, there is provided a turbocharging device of a bifuel engine using a gas fuel and a liquid fuel as fuels, and having a turbocharger compressing a large amount of intake air into a combustion chamber of the engine by driving a compressor arranged in an intake passage of the engine by a turbine arranged in an exhaust passage of the engine. The compressing by the compressor of the turbocharger is performed when the gas fuel is used, and the compressing by the compressor of the turbocharger is not performed when the liquid fuel is used.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a schematic view showing a supercharging device of a bifuel engine of an embodiment 1; and.

FIG. 2 is a schematic view showing a supercharging device of a bifuel engine of an embodiment 2.

### DESCRIPTION OF THE PREFERRED EMBODIMENTS

### Embodiment 1

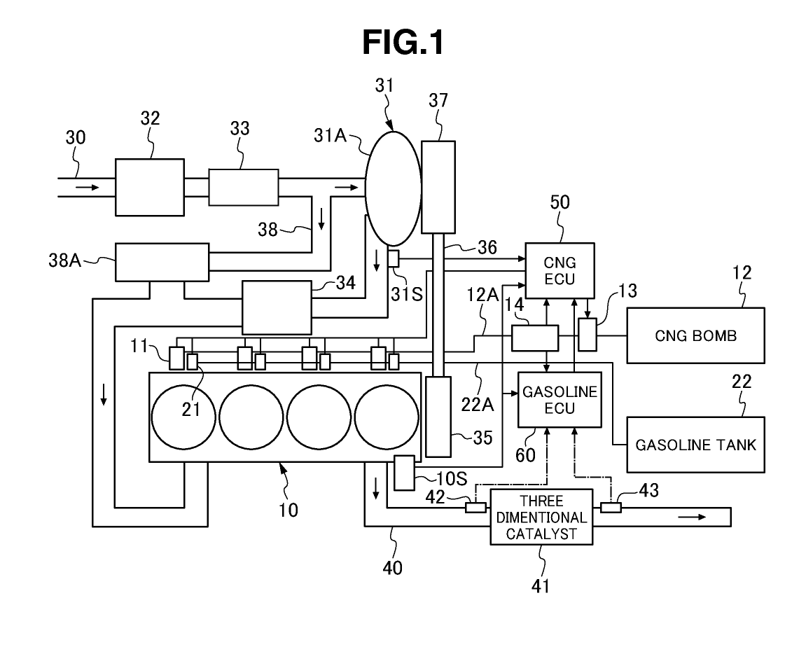

### FIG. 1

A bifuel engine 10 shown in FIG. 1 uses CNG (gas fuel) and gasoline (liquid fuel) as fuels.

Specifically, the engine 10 has a CNG injector 11 and a gasoline injector 21. The CNG filling a CNG tank 12 under a pressure is fed to a CNG injector 11 through a fuel line 12A, and is injected into a combustion chamber of the engine 10 through the CNG injector 11. This fuel line 12A is provided with a shunt valve 13 for cutting of the CNG and a high-pressure CNG pressure sensor 14 measuring the pressure in the CNG tank 12. A remaining quantity in the CNG tank 12 is monitored according to the pressure measured by the high-pressure CNG pressure sensor 14. The gasoline filling a gasoline tank 22 is fed through a fuel line 22A to the gasoline injector 21, and is injected into the combustion chamber of the engine 10 through the gasoline injector 21.

A compressor 31A of a supercharger 31 is arranged in an intake passage 30 introducing a combustion air into the combustion chamber of the engine 10. In the intake passage 30, an air cleaner 32 and an airflow meter 33 are arranged upstream to the compressor 31A. The air cleaner 32 filters out dust and the like in the intake air taken into the intake passage 30, and the airflow meter 33 measures the quantity of the intake air taken thereinto. The compressor 31A of the supercharger 31 compresses (i.e., supercharges) the intake air taken through the air cleaner 32 and the airflow meter 33. The intake air that becomes hot due to the pressurizing by the compressor 31A is cooled by an intercooler 34 arranged downstream from the compressor 31A, and is supplied to the combustion chamber of the engine 10. The intake air is supercharged by the compressor 31A and is densified by the intercooler 34 to improve an efficiency of filling into the combustion chamber of the engine 10, and a large amount of air is supplied into the combustion chamber of the engine 10.

The compressor 31A of the supercharger 31 receives a rotation power of a drive source 35 through a drive transmission unit 36 and an electromagnetic clutch 37. The drive source 35 is the output of the engine 10. A belt serving as the drive transmission unit 36 is looped around a drive pulley arranged on a crankshaft (output shaft) of the engine 10 and a driven pulley arranged on an input shaft of the electromagnetic clutch 37. An output shaft of the electromagnetic clutch 37 is coupled to the compressor 31A. When the electromagnetic clutch 37 is engaged (i.e., turned on), the output of the engine 10 drives the compressor 31A.

The compressor 31A of the supercharger 31 may be driven by the output of an electric motor without using the output of the engine 10.

An intake bypass passage 38 detouring around the compressor 31A of the supercharger 31 extends to connect a portion intermediate between the airflow meter 33 in the intake passage 30 and the compressor 31A to a downstream portion of the intercooler 34 (or upstream portion of the intercooler 34). The intake bypass passage 38 is provided with an intake bypass valve (electromagnetic valve) 38A for opening and closing the intake bypass passage 38. The intake bypass valve 38A opens when the supercharging pressure by the compressor 31A of the supercharger 31 is to be reduced, or the compressor 31A is to be stopped.

An exhaust passage 40 for discharging the exhaust gas from the combustion chamber of the engine 10 is provided with a three-dimensional catalyst 41 cleaning the exhaust. The three-dimensional catalyst 41 performs the oxidation or reduction processing on the CO, HC and NOx to change them into harmless CO₂, N₂ and H₂O. An A/F sensor 42 is arranged upstream to the three-dimensional catalyst 41 in the exhaust passage 40. An O₂ sensor 43 is arranged downstream therefrom. The A/F sensor 42 detects a difference in concentration between the oxygen amount in the exhaust and the oxygen amount in the atmosphere, and detects an air-to-fuel ratio (i.e., ratio between the fuel and the air). The O₂ sensor 43 detects the oxygen concentration in the exhaust gas. The results of detection of the A/F sensor 42 and the O₂ sensor 43 are sent to an ECU (genuine ECU 60).

A CNG ECU 50 (i.e., ECU for the CNG) and the gasoline ECU 60 (i.e., ECU for the gasoline) control the engine 10.

In this embodiment, the gasoline ECU 60 performs the A/F feedback control in which the A/F sensor 42 and the O₂ sensor 43 send detection signals thereof to the genuine ECU, i.e., the gasoline ECU 60, it is detected from the detection result of the A/F sensor 42 that the air-fuel ratio of the exhaust gas is controlled to take a value required for activating the three-dimensional catalyst 41 and it is also detected from the detection result of the O₂ sensor 43 that the oxidation or reduction processing of the three-dimensional catalyst 41 is appropriately performed. Also, the CNG ECU 50 performs the A/F feedback control, using the A/F feedback control of the gasoline ECU 60.

In this embodiment, a water temperature sensor 10S arranged on the engine 10 detects the temperature of the cooling water of the engine 10. The water temperature sensor 10S sends the detection signal to the CNG ECU 50 and gasoline ECU 60. At the time of extremely cold start (abnormal drive), i.e., when the detected temperature of the water temperature sensor 10S is extremely low, the gasoline ECU 60 performs the gasoline drive using the gasoline as the fuel of the engine 10. When the detected temperature of the water temperature sensor 10S is not extremely low (i.e., during the normal drive including the normal cold start), the CNG ECU 50 performs the CNG drive control using the CNG as the fuel of the engine 10.

In this embodiment, the high-pressure CNG pressure sensor 14 measuring the pressure of the CNG tank 12 likewise sends its detection signal to the CNG ECU 50 and the gasoline ECU 60. When the detected pressure of the high-pressure CNG pressure sensor 14 lowers to or below a reference value (i.e., during the abnormal driving), the CNG ECU 50 stops the CNG drive control of the engine 10, and the gasoline ECU 60 starts the gasoline drive control of the engine 10. Such a configuration may be employed that a driver can freely switch the control between the CNG drive control of the engine 10 by the CNG ECU 50 and the gasoline drive control of the engine 10 by the gasoline ECU 60.

The CNG drive control and the gasoline drive control will be described below.

(CNG Drive Control)

When the CNG is used, i.e., during the normal drive of the engine 10, CNG ECU 50 performs the drive control of the engine 10 based on the information provided from the various sensors and the genuine ECU, i.e., the gasoline ECU 60. The electromagnetic clutch 37 connects the output of the engine 10 to the compressor 31A of the supercharger 31, and the compressor 31A performs the supercharging. The large amount of intake air supercharged by the compressor 31A is supplied to the combustion chamber of the engine 10. More specifically, the air taken from the air cleaner 32 of the intake passage 30 is compressed by the compressor 31A of the supercharger 31 after the flow-rate measuring by the airflow meter 33, then is cooled by the intercooler 34 and is supercharged into the combustion chamber of the engine 10.

At this time, the CNG ECU 50 sets the intake bypass valve 38A arranged in the intake bypass passage 38 detouring the compressor 31A of the supercharger 31 to the fully closed position or to the closing side. The CNG ECU 50 performs the open/close control of the intake bypass valve 38A based on an output value of a supercharge pressure sensor 31S positioned downstream from the compressor 31A in the intake passage 30, and thereby controls the pressure of the CNG supercharged by the compressor 31A within a range not exceeding the allowed maximum limit supercharging pressure for the CNG.

(Gasoline Drive Control)

In the abnormal drive operation of the engine 10, i.e., when the gasoline is used, the gasoline ECU 60 controls the drive of the engine 10 based on the information provided from the various sensors. The electromagnetic clutch 37 cuts off the connection of the output of the engine 10 from the compressor 31A of the supercharger 31 to stop the supercharging by the compressor 31A. The intake air which is not supercharged by the compressor 31A is supplied to the combustion chamber of the engine 10. More specifically, the air taken from the air cleaner 32 of the intake passage 30 is supplied to the combustion chamber of the engine 10 after the airflow meter 33 measures the flow rate thereof.

In this operation, the compressor 31A of the supercharger 31 not driven due to the disengagement of the electromagnetic clutch 37 acts as the intake resistance of the compressor 31A, the CNG ECU 50 fully opens the intake bypass valve 38A arranged in the intake bypass passage 38 detouring the compressor 31A of the supercharger 31. The intake air passed through the airflow meter 33 is supplied to the combustion chamber of the engine 10 through the intake bypass passage 38.

This embodiment achieves the following operations and effects.

(a) During the normal operation (including the normal cold start operation) of the engine 10, the gas fuel of a high octane number (e.g., the CNG has the octane number of 120) is used. The compressor 31A of the supercharger 31 driven by the output of the engine 10 or the electric motor performs on this gas fuel the supercharging that allows the supercharging pressure control attaining the high maximum limit supercharging pressure for the gas fuel suppressing preignition or knocking. Thereby, the output of the engine 10 can be increased by attaining the high fuel efficiency of the engine 10 preventing the damages of the engine parts, the output lowering and the like due to occurrence of the knocking.

In contrast to the above, when the liquid fuel of the low octane number (e.g., the gasoline has the octane number of 90-100) is used during the abnormal operation of the engine 10 (e.g., during the extremely cold start or when the tank pressure of the gas fuel is low), the supercharging by the compressor 31A of the supercharger 31 is not performed at all.

This can increase the output of the bifuel engine 10 while achieving such simplification that the supercharge pressure control by the supercharger 31 is applied only to the gas fuel.

(b) The electromagnetic clutch 37 is arranged between the output shaft of the engine 10 or the electric motor and the compressor 31A of the supercharger 31, the electromagnetic clutch 37 is engaged when the gas fuel is used, and the electromagnetic clutch 37 is disengaged when the liquid fuel is used. Accordingly, the switching between the execution and the inexecution of the supercharging described in the above (a) can be simply switched by turning on/off (engaging/disengaging) the electromagnetic clutch 37 according to the switching of use between the gas fuel and the liquid fuel.

(c) The intake bypass passage 38 detouring the compressor 31A of the supercharger 31 and the intake bypass valve 38A for opening and closing the intake bypass passage 38 are arranged. The intake bypass valve 38A closes when the gas fuel is used, and the intake bypass valve 38A opens when the liquid fuel is used. Thereby, when the liquid fuel is used, the intake air not supercharged by the compressor 31A of the supercharger 31 can be fed into the combustion chamber through the intake bypass passage 38 detouring the compressor 31A, and the intake resistance due to the compressor 31A can be eliminated.

(d) When the gas fuel is used at the time of the cold start of the engine 10 and further the compressor 31A of the supercharger 31 performs the supercharging on this gas fuel, the temperature lowering of the exhaust gas does not occur in contrast to the case where the turbocharger is used. Thus, in this cold start operation, the temperature lowering of the exhaust gas due to contact with the turbine of the turbocharger does not occur, and consequently the exhaust heat rapidly raises the temperature of the exhaust gas cleaning catalyst 41 on the exhaust downstream side. This promotes the increase in reduction performance of the exhaust gas cleaning catalyst 41 to improve the exhaust gas cleaning performance.

### Embodiment 2

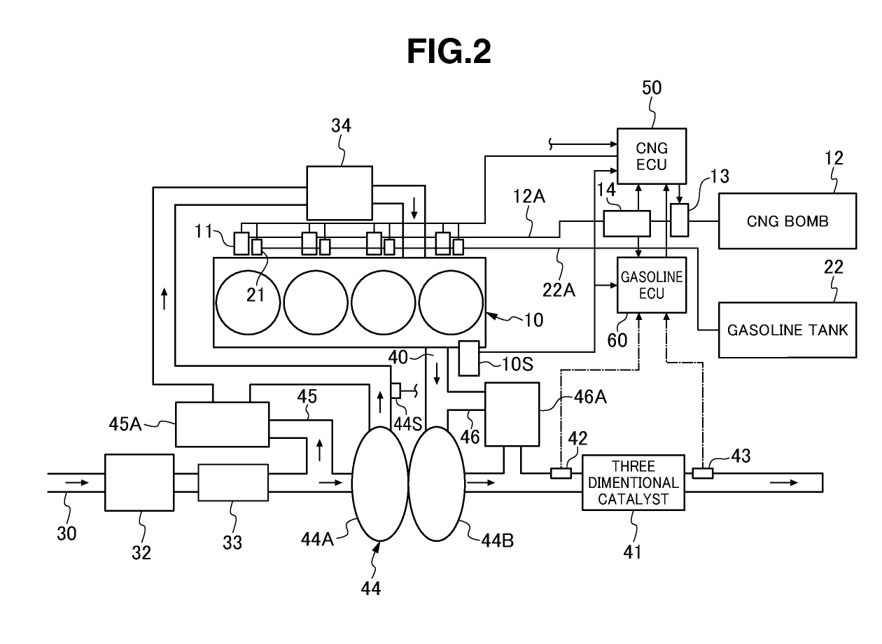

### FIG. 2

An embodiment 2 is different from the embodiment 1 in that a turbocharger 44 is used in place of the supercharger 31 as the means for supercharging a large amount of intake air into the combustion chamber of the engine 10 when the CNG is used. In the embodiment 2, the members similar to those in the embodiment 1 bear the same reference numbers, and description thereof will not be repeated.

The turbocharger 44 has a compressor 44A arranged downstream from the airflow meter 33 in the intake passage 30 and a turbine 44B arranged upstream to the three-dimensional catalyst 41 in the exhaust passage 40. The turbocharger 44 turbocharges a large amount of intake air into the combustion chamber of the engine 10 by driving the compressor 44A by the turbine 44B that is rotated by the exhaust pressure of the engine 10.

The turbocharger 44 is accompanied with an intake bypass passage 45 detouring the compressor 44A and an intake bypass valve 45A for opening and closing the intake bypass passage 45. The intake bypass passage 45 extends to connect an intermediate portion of the intake passage 30 between the airflow meter 33 and the compressor 44A to an upstream portion of the intercooler 34 (or downstream portion of the intercooler 34).

The turbocharger 44 is also accompanied with an exhaust bypass passage 46 detouring the turbine 44B and an exhaust bypass valve 46A for opening and closing the exhaust bypass passage 46. The exhaust bypass passage 46 extends to connect a portion of the exhaust passage 40 upstream to the turbine 44B to the intermediate portion between the turbine 44B and the three-dimensional catalyst 41. The intake bypass valve 45A and the exhaust bypass valve 46A open when the turbocharging pressure of the compressor 44A of the turbocharger 44 is to be reduced or the compressor 44A is to be stopped.

In this embodiment, the CNG ECU 50 and the gasoline ECU 60 control the engine 10.

More specifically, In this embodiment, the gasoline ECU 60 performs the A/F feedback control in which the A/F sensor 42 and the O₂ sensor 43 send detection signals thereof to the genuine ECU, i.e., the gasoline ECU 60, it is detected from the detection result of the A/F sensor 42 that the air-fuel ratio of the exhaust gas is controlled to take a value required for activating the three-dimensional catalyst 41 and it is also detected from the detection result of the O₂ sensor 43 that the oxidation or reduction processing of the three-dimensional catalyst 41 is appropriately performed. Also, the CNG ECU 50 performs the A/F feedback control, using the A/F feedback control of the gasoline ECU 60.

In this embodiment, a water temperature sensor 10S arranged on the engine 10 detects the temperature of the cooling water of the engine 10. The water temperature sensor 10S sends the detection signal to the CNG ECU 50 and gasoline ECU 60. At the time of extremely cold start (abnormal drive), i.e., when the detected temperature of the water temperature sensor 10S is extremely low, the gasoline ECU 60 performs the gasoline drive using the gasoline as the fuel of the engine 10. When the detected temperature of the water temperature sensor 10S is not extremely low (i.e., during the normal drive including the normal cold start), the CNG ECU 50 performs the CNG drive control using the CNG as the fuel of the engine 10.

In this embodiment, the high-pressure CNG pressure sensor 14 measuring the pressure of the CNG tank 12 likewise sends its detection signal to the CNG ECU 50 and the gasoline ECU 60. When the detected pressure of the high-pressure CNG pressure sensor 14 lowers to or below a reference value (i.e., during the abnormal driving), the CNG ECU 50 stops the CNG drive control of the engine 10, and the gasoline ECU 60 starts the gasoline drive control of the engine 10. Such a configuration may be employed that a driver can freely switch the control between the CNG drive control of the engine 10 by the CNG ECU 50 and the gasoline drive control of the engine 10 by the gasoline ECU 60.

The CNG drive control and the gasoline drive control will be described below.

(CNG Drive Control)

When the CNG is used, i.e., during normal driving of the engine 10, CNG ECU 50 performs the drive control of the engine 10 based on the information provided from the various sensors and the genuine ECU, i.e., the gasoline ECU 60. The CNG ECU 50 operates to rotate the turbine 44B of the turbocharger 44 by the exhaust pressure of the engine 10 so that a large amount of intake air turbocharged by the compressor 44A driven by the turbine 44B is supplied into the combustion chamber of the engine 10. More specifically, the air taken from the air cleaner 32 of the intake passage 30 is compressed by the compressor 44A of the turbocharger 44 after the flow-rate measuring by the airflow meter 33, then is cooled by the intercooler 34 and is turbocharged into the combustion chamber of the engine 10.

At this time, the CNG ECU 50 sets the intake bypass valve 45A arranged in the intake bypass passage 45 detouring the compressor 44A of the turbocharger 44 as well as the exhaust bypass valve 46A arranged in the exhaust bypass passage 46 detouring the turbine 44B of the turbocharger 44 to the fully closed position or to the closing side. The CNG ECU 50 performs the open/close control of the intake bypass valve 45A and the exhaust bypass valve 46A based on an output value of a turbocharge pressure sensor 44S positioned downstream from the compressor 44A in the intake passage 30, and thereby controls the pressure of the CNG turbocharged by the compressor 44A within a range not exceeding the allowed maximum limit supercharging pressure for the CNG.

(Gasoline Drive Control)

In the abnormal drive operation of the engine 10, i.e., when the gasoline is used, the gasoline ECU 60 controls the drive of the engine 10 based on the information provided from the various sensors. In this operation, the CNG ECU 50 fully opens both the intake bypass valve 45A and the exhaust bypass valve 46A to stop the rotation of the turbine 44B of the turbocharger 44 that is produced by the exhaust pressure of the engine 10, and thereby stops the supercharging performed by the compressor 44A. The intake air which is not turbocharged by the compressor 44A is supplied into the combustion chamber of the engine 10. More specifically, the air taken from the air cleaner 32 of the intake passage 30 is supplied through the intake bypass passage 45 into the combustion chamber of the engine 10 after the airflow meter 33 measures the flow rate thereof.

This embodiment achieves the following operations and effects.

(a) During normal operation (including the normal cold start operation) of the engine 10, the gas fuel of a high octane number (e.g., the CNG has the octane number of 120) is used. The compressor 44A of the turbocharger 44 driven by the output of the engine 10 or the electric motor performs on this gas fuel the turbocharging that allows the turbocharging pressure control attaining the high maximum limit turbocharging pressure for the gas fuel suppressing such knocking. Thereby, the output of the engine 10 can be increased by attaining the high fuel efficiency of the engine 10 preventing the damages of the engine parts, the output lowering and the like due to occurrence of the preignition or knocking.

In contrast to the above, when the liquid fuel of the low octane number (e.g., the gasoline has the octane number of 90-100) is used during the abnormal operation of the engine 10 (e.g., during the extremely cold start or when the tank pressure of the gas fuel is low), the turbocharging by the compressor 44A of the turbocharger 44 is not performed at all.

This can increase the output of the bifuel engine 10 while achieving such simplification that the turbocharging pressure control by the turbocharger 44 is applied only to the gas fuel.

(b) The exhaust bypass passage 46 detouring the turbine 44B of the turbocharger 44 and the exhaust bypass valve 46A for opening and closing the exhaust bypass passage 46 are employed. Also, the intake bypass passage 45 detouring the compressor 44A of the turbocharger 44 and the intake bypass valve 45A for opening and closing the intake bypass passage 45 are employed. When the gas fuel is used, the exhaust bypass valve 46A and intake bypass valve 45A are closed. When the liquid fuel is used, the exhaust bypass valve 46A and intake bypass valve 45A are open. Therefore, by turning on/off (closing/opening) the exhaust bypass valve 46A and the intake bypass valve 45A according to the switching of use between the gas fuel and the liquid fuel, the switching between execution and inexecution of the supercharging in the foregoing (a) can be simply performed.

The matters of disclosure of the present invention are as follows.

A supercharging device of a bifuel engine using a gas fuel and a liquid fuel as fuels, and having a supercharger supercharging a large amount of intake air into a combustion chamber of the engine by driving a compressor arranged in an intake passage of the engine by an output shaft of the engine or an electric motor, wherein

the supercharging by the compressor of the supercharger is performed when the gas fuel is used, and the supercharging by the compressor of the supercharger is not performed when the liquid fuel is used.

A further embodiment of the supercharging device of the bifuel engine discloses

an electromagnetic clutch is arranged between the output shaft of the engine or the electric motor and the compressor of the supercharger, and

the electromagnetic clutch is engaged when the gas fuel is used, and is disengaged when the liquid fuel is used.

A further embodiment of the supercharging device of the bifuel engine discloses

an intake bypass passage detouring the compressor of the supercharger and an intake bypass valve for opening and closing the intake bypass passage are arranged, and

the intake bypass valve is closed when the gas fuel is used, and is open when the liquid fuel is used.

A further embodiment of the supercharging device of the bifuel engine discloses

an exhaust gas cleaning catalyst is arranged in an exhaust passage of the engine.

A further embodiment of the supercharging device of the bifuel engine discloses

the engine is controlled by a gas fuel EPU and a liquid fuel EPU,

a water temperature sensor arranged on the engine detects the temperature of the cooling water of the engine, and the water temperature sensor sends the detection signal to the gas fuel ECU and liquid fuel ECU,

when the detected temperature of the water temperature sensor is extremely low, the liquid fuel ECU performs the liquid fuel drive using the liquid fuel as the fuel of the engine, and

when the detected temperature of the water temperature sensor is not extremely low, the gas fuel ECU performs the gas fuel drive control using the gas fuel as the fuel of the engine.

A further embodiment of the supercharging device of the bifuel engine discloses

the engine has a gas fuel injector and a liquid fuel injector, and the gas fuel filling a gas fuel tank under a pressure is fed to a gas fuel injector through a fuel line, and is injected into a combustion chamber of the engine through the gas fuel injector,

the high-pressure gas fuel pressure sensor measuring the pressure of the gas fuel tank likewise sends its detection signal to the gas fuel ECU and the liquid fuel ECU, and

when the detected pressure of the high-pressure gas fuel pressure sensor lowers to or below a reference value, the gas fuel ECU stops the gas fuel drive control of the engine, and the liquid fuel ECU starts the liquid fuel drive control of the engine.

A control method for the supercharging device of the bifuel engine discloses

when the gas fuel is used during the normal drive of the engine, gas fuel ECU performs the drive control of the engine, and the electromagnetic clutch connects the output of the engine to the compressor of the supercharger, and the large amount of intake air supercharged by the compressor is supplied to the combustion chamber of the engine,

in the abnormal drive operation of the engine, when the liquid fuel is used, the liquid fuel ECU controls the drive of the engine, and the electromagnetic clutch cuts off the connection of the output of the engine from the compressor of the supercharger to stop the supercharging by the compressor, and the intake air which is not supercharged by the compressor is supplied to the combustion chamber of the engine.

A further embodiment of the supercharging device of the bifuel engine discloses

when the gas fuel is used during the normal drive of the engine,

the gas fuel ECU sets the intake bypass valve arranged in the intake bypass passage detouring the compressor of the supercharger to the fully closed position or to the closing side, and

the gas fuel ECU performs the open/close control of the intake bypass valve based on an output value of a supercharge pressure sensor positioned downstream from the compressor in the intake passage, and thereby controls the pressure of the gas fuel supercharged by the compressor within a range not exceeding the allowed maximum limit supercharging pressure for the gas fuel.

A further embodiment of the supercharging device of the bifuel engine discloses

when the liquid fuel is used during the abnormal drive of the engine,

the gas fuel ECU fully opens the intake bypass valve arranged in the intake bypass passage detouring the compressor of the supercharger, and the intake air passed through the airflow meter is supplied to the combustion chamber of the engine through the intake bypass passage.

A supercharging device of a bifuel engine using a gas fuel and a liquid fuel as fuels, and having a turbocharger supercharging a large amount of intake air into a combustion chamber of the engine by driving a compressor arranged in an intake passage of the engine by a turbine arranged in an exhaust passage of the engine, wherein

the supercharging by the compressor of the turbocharger is performed when the gas fuel is used, and the supercharging by the compressor of the turbocharger is not performed when the liquid fuel is used.

A further embodiment of the supercharging device of the bifuel engine discloses

an exhaust bypass passage detouring the turbine of the turbocharger and an exhaust bypass valve for opening and closing the exhaust bypass passage are arranged,

an intake bypass passage detouring the compressor of the turbocharger and an intake bypass valve for opening and closing the intake bypass passage are arranged, and

the exhaust bypass valve and the intake bypass valve are closed when the gas fuel is used, and the exhaust bypass valve and the intake bypass valve are open when the liquid fuel is used.

A further embodiment of the supercharging device of the bifuel engine discloses

the engine is controlled by a gas fuel EPU and a liquid fuel EPU,

a water temperature sensor arranged on the engine detects the temperature of the cooling water of the engine, and the water temperature sensor sends the detection signal to the gas fuel ECU and liquid fuel ECU,

when the detected temperature of the water temperature sensor is extremely low, the liquid fuel ECU performs the liquid fuel drive using the liquid fuel as the fuel of the engine, and

when the detected temperature of the water temperature sensor is not extremely low, the gas fuel ECU performs the gas fuel drive control using the gas fuel as the fuel of the engine.

A further embodiment of the supercharging device of the bifuel engine discloses

the engine has a gas fuel injector and a liquid fuel injector, and the gas fuel filling a gas fuel tank under a pressure is fed to a gas fuel injector through a fuel line, and is injected into a combustion chamber of the engine through the gas fuel injector,

the high-pressure gas fuel pressure sensor measuring the pressure of the gas fuel tank likewise sends its detection signal to the gas fuel ECU and the liquid fuel ECU, and

when the detected pressure of the high-pressure gas fuel pressure sensor lowers to or below a reference value, the gas fuel ECU stops the gas fuel drive control of the engine, and the liquid fuel ECU starts the liquid fuel drive control of the engine.

A control method for the supercharging device of the bifuel engine discloses

when the gas fuel is used during the normal drive of the engine, gas fuel ECU performs the drive control of the engine, and the gas fuel ECU operates to rotate the turbine of the turbocharger by the exhaust pressure of the engine so that a large amount of intake air supercharged by the compressor driven by the turbine is supplied into the combustion chamber of the engine, and

in the abnormal drive operation of the engine, when the liquid fuel is used, the liquid fuel ECU controls the drive of the engine, and the gas fuel ECU fully opens both the intake bypass valve and the exhaust bypass valve to stop the rotation of the turbine of the turbocharger that is produced by the exhaust pressure of the engine, and thereby stops the supercharging performed by the compressor, and the intake air which is not supercharged by the compressor is supplied into the combustion chamber of the engine.

A control method for the supercharging device of the bifuel engine discloses

when the gas fuel is used during the normal drive of the engine,

the gas fuel ECU sets the intake bypass valve arranged in the intake bypass passage detouring the compressor of the turbocharger as well as the exhaust bypass valve arranged in the exhaust bypass passage detouring the turbine of the turbocharger to the fully closed position or to the closing side, and

the gas fuel ECU performs the open/close control of the intake bypass valve and the exhaust bypass valve based on an output value of a supercharge pressure sensor positioned downstream from the compressor in the intake passage, and thereby controls the pressure of the gas fuel supercharged by the compressor within a range not exceeding the allowed maximum limit supercharging pressure for the gas fuel.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention. For example, the gas fuel is not restricted to the CNG, and the liquid fuel is not restricted to the gasoline.

In accordance with the present invention, there is provided a supercharging device of a bifuel engine using a gas fuel and a liquid fuel as fuels, and having a supercharger supercharging a large amount of intake air into a combustion chamber of the engine by driving a compressor arranged in an intake passage of the engine by an output shaft of the engine or an electric motor. The supercharging by the compressor of the supercharger is performed when the gas fuel is used, and the supercharging by the compressor of the supercharger is not performed when the liquid fuel is used. Accordingly, it is possible to increase easily an output of a bifuel engine.

Also, in accordance with the present invention, an exhaust gas cleaning catalyst is arranged in an exhaust passage of the engine. Accordingly, it is possible to improve an exhaust gas cleaning performance by avoiding delay in temperature rising of an exhaust gas cleaning catalyst.

In accordance with the present invention, there is provided a turbocharging device of a bifuel engine using a gas fuel and a liquid fuel as fuels, and having a turbocharger turbocharging a large amount of intake air into a combustion chamber of the engine by driving a compressor arranged in an intake passage of the engine by a turbine arranged in an exhaust passage of the engine. The turbocharging by the compressor of the turbocharger is performed when the gas fuel is used, and the turbocharging by the compressor of the turbocharger is not performed when the liquid fuel is used. Accordingly, it is possible to increase easily an output of a bifuel engine.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A supercharging device of a bifuel engine using a gas fuel and a liquid fuel as fuels, and having a supercharger supercharging a large amount of intake air into a combustion chamber of the engine by driving a compressor arranged in an intake passage of the engine by an output shaft of the engine or an electric motor, wherein
the supercharging by the compressor of the supercharger is performed when the gas fuel is used, and the supercharging by the compressor of the supercharger is not performed when the liquid fuel is used.

2. The supercharging device of the bifuel engine according to claim 1, wherein
an electromagnetic clutch is arranged between the output shaft of the engine or the electric motor and the compressor of the supercharger, and
the electromagnetic clutch is engaged when the gas fuel is used, and is disengaged when the liquid fuel is used.

3. The supercharging device of the bifuel engine according to claim 2, wherein
an intake bypass passage detouring the compressor of the supercharger and an intake bypass valve for opening and closing the intake bypass passage are arranged, and
the intake bypass valve is closed when the gas fuel is used, and is open when the liquid fuel is used.

4. The supercharging device of the bifuel engine according to claim 1, wherein
an exhaust gas cleaning catalyst is arranged in an exhaust passage of the engine.

5. The supercharging device of the bifuel engine according to claim 1, wherein
the engine is controlled by a gas fuel EPU and a liquid fuel EPU,
a water temperature sensor arranged on the engine detects the temperature of the cooling water of the engine, and the water temperature sensor sends the detection signal to the gas fuel ECU and liquid fuel ECU,
when the detected temperature of the water temperature sensor is extremely low, the liquid fuel ECU performs the liquid fuel drive using the liquid fuel as the fuel of the engine, and
when the detected temperature of the water temperature sensor is not extremely low, the gas fuel ECU performs the gas fuel drive control using the gas fuel as the fuel of the engine.

6. The supercharging device of the bifuel engine according to claim 5, wherein
the engine has a gas fuel injector and a liquid fuel injector, and the gas fuel filling a gas fuel tank under a pressure is fed to a gas fuel injector through a fuel line, and is injected into a combustion chamber of the engine through the gas fuel injector,
the high-pressure gas fuel pressure sensor measuring the pressure of the gas fuel tank likewise sends its detection signal to the gas fuel ECU and the liquid fuel ECU, and
when the detected pressure of the high-pressure gas fuel pressure sensor lowers to or below a reference value, the gas fuel ECU stops the gas fuel drive control of the engine, and the liquid fuel ECU starts the liquid fuel drive control of the engine.

7. A control method for the supercharging device of the bifuel engine according to claim 1, wherein
when the gas fuel is used during the normal drive of the engine, gas fuel ECU performs the drive control of the engine, and the electromagnetic clutch connects the output of the engine to the compressor of the supercharger, and the large amount of intake air supercharged by the compressor is supplied to the combustion chamber of the engine, and
in the abnormal drive operation of the engine, when the liquid fuel is used, the liquid fuel ECU controls the drive of the engine, and the electromagnetic clutch cuts off the connection of the output of the engine from the compressor of the supercharger to stop the supercharging by the compressor, and the intake air which is not supercharged by the compressor is supplied to the combustion chamber of the engine.

8. The supercharging device of the bifuel engine according to claim 7, wherein
when the gas fuel is used during the normal drive of the engine,
the gas fuel ECU sets the intake bypass valve arranged in the intake bypass passage detouring the compressor of the supercharger to the fully closed position or to the closing side, and
the gas fuel ECU performs the open/close control of the intake bypass valve based on an output value of a supercharge pressure sensor positioned downstream from the compressor in the intake passage, and thereby controls the pressure of the gas fuel supercharged by the compressor within a range not exceeding the allowed maximum limit supercharging pressure for the gas fuel.

9. The supercharging device of the bifuel engine according to claim 7, wherein
when the liquid fuel is used during the abnormal drive of the engine,
the gas fuel ECU fully opens the intake bypass valve arranged in the intake bypass passage detouring the compressor of the supercharger, and the intake air passed through the airflow meter is supplied to the combustion chamber of the engine through the intake bypass passage.

10. A turbocharging device of a bifuel engine using a gas fuel and a liquid fuel as fuels, and having a turbocharger turbocharging a large amount of intake air into a combustion chamber of the engine by driving a compressor arranged in an intake passage of the engine by a turbine arranged in an exhaust passage of the engine, wherein
the turbocharging by the compressor of the turbocharger is performed when the gas fuel is used, and the turbocharging by the compressor of the turbocharger is not performed when the liquid fuel is used.

11. The turbocharging device of the bifuel engine according to claim 10, wherein
an exhaust bypass passage detouring the turbine of the turbocharger and an exhaust bypass valve for opening and closing the exhaust bypass passage are arranged,
an intake bypass passage detouring the compressor of the turbocharger and an intake bypass valve for opening and closing the intake bypass passage are arranged, and
the exhaust bypass valve and the intake bypass valve are closed when the gas fuel is used, and the exhaust bypass valve and the intake bypass valve are open when the liquid fuel is used.

12. The turbocharging device of the bifuel engine according to claim 10, wherein
the engine is controlled by a gas fuel EPU and a liquid fuel EPU,
a water temperature sensor arranged on the engine detects the temperature of the cooling water of the engine, and the water temperature sensor sends the detection signal to the gas fuel ECU and liquid fuel ECU,
when the detected temperature of the water temperature sensor is extremely low, the liquid fuel ECU performs the liquid fuel drive using the liquid fuel as the fuel of the engine, and
when the detected temperature of the water temperature sensor is not extremely low, the gas fuel ECU performs the gas fuel drive control using the gas fuel as the fuel of the engine.

13. The turbocharging device of the bifuel engine according to claim 12, wherein
the engine has a gas fuel injector and a liquid fuel injector, and the gas fuel filling a gas fuel tank under a pressure is fed to a gas fuel injector through a fuel line, and is injected into a combustion chamber of the engine through the gas fuel injector,
the high-pressure gas fuel pressure sensor measuring the pressure of the gas fuel tank likewise sends its detection signal to the gas fuel ECU and the liquid fuel ECU, and
when the detected pressure of the high-pressure gas fuel pressure sensor lowers to or below a reference value, the gas fuel ECU stops the gas fuel drive control of the engine, and the liquid fuel ECU starts the liquid fuel drive control of the engine.

14. A control method for the turbocharging device of the bifuel engine according to claim 10, wherein
when the gas fuel is used during the normal drive of the engine, gas fuel ECU performs the drive control of the engine, and the gas fuel ECU operates to rotate the turbine of the turbocharger by the exhaust pressure of the engine so that a large amount of intake air supercharged by the compressor driven by the turbine is supplied into the combustion chamber of the engine, and
in the abnormal drive operation of the engine, when the liquid fuel is used, the liquid fuel ECU controls the drive of the engine, and the gas fuel ECU fully opens both the intake bypass valve and the exhaust bypass valve to stop the rotation of the turbine of the turbocharger that is produced by the exhaust pressure of the engine, and thereby stops the turbocharging performed by the compressor, and the intake air which is not turbocharging by the compressor is supplied into the combustion chamber of the engine.

15. A control method for the turbocharging device of the bifuel engine according to claim 14, wherein
when the gas fuel is used during the normal drive of the engine,
the gas fuel ECU sets the intake bypass valve arranged in the intake bypass passage detouring the compressor of the turbocharger as well as the exhaust bypass valve arranged in the exhaust bypass passage detouring the turbine of the turbocharger to the fully closed position or to the closing side, and
the gas fuel ECU performs the open/close control of the intake bypass valve and the exhaust bypass valve based on an output value of a turbocharging pressure sensor positioned downstream from the compressor in the intake passage, and thereby controls the pressure of the gas fuel turbocharging by the compressor within a range not exceeding the allowed maximum limit turbocharging pressure for the gas fuel.
